(19) United States
(12) Patent Application Publication
(10) Pub. No.: US 2008/0100014 A1
(43) Pub. Date: May 1, 2008

(54) Combination jogging apparatus and stroller

(76) Inventor: Giovanna Tripiano, Long Beach, CA (US)

Correspondence Address: JAMES RAY & ASSOCIATES, 2640 PITCAIRN ROAD, MONROEVILLE, PA, 15146, US

(21) Appl. No.: 11/973,460

(22) Filed: Oct. 9, 2007

Related U.S. Application Data
(60) Provisional application No. 60/850,950, filed on Oct. 10, 2006.

(51) Int. Cl. B62B 9/20; B62B 7/04

(52) U.S. Cl. 280/47.371

(57) ABSTRACT

A combination jogging apparatus and stroller is provided. A stroller member includes a frame member, a pair of rear wheels connected operably to such frame member, and at least one front wheel connected operably to such frame member. Such frame member has a seat portion disposed therein and a handle bar attached to an upper end of thereof. A pair of handle members are rotatably connected to the handle bar such that the handle members move up and down and back and forth in fluid motion with a user's arms when such user is jogging.

### CROSS REFERENCE TO RELATED APPLICATION

This patent application is related to and claims priority from U.S. Provisional Patent Application Ser. No. 60/850,950 filed Oct. 10, 2006.

### FIELD OF THE INVENTION

The present invention relates, in general, to strollers and, more particularly, this invention relates to jogging strollers.

### BACKGROUND OF THE INVENTION

Prior to the conception and development of the present invention, jogging strollers as are generally well known in the prior art, have been used by persons interested in exercising while caring for a child or children. Specifically of interest to the present invention are the following: Kreamer, U.S. Pat. No. 6,722,689 discloses a jogging stroller for carrying a baby which includes three wheels mounted on a frame that holds a cloth seat and includes frame rails that project upwardly and rearwardly from a single front wheel to a horizontal handlebar member at the rear of the stroller, along with a pair of handles attached to the handlebar members by a clamp and these include a stem member that extends outwardly from the stroller handlebar and are connected to a perpendicular handle element that can rotate about the stem member and the stem members can be rotated about the axis of the horizontal stroller handlebar and can be slid along the handlebar. The handle elements can be fixed in space in a position desired by the user or can be left loose enough to rotate during use.

Archey, U.S. Pat. No. 5,876,309 discloses a jogging exercise stroller which includes a stroller portion defined by a frame member which has a pair of rear wheels and a forward wheel, a seat portion, a lower cross bar and an upper cross bar. A pair of arcuate handles are coupled with the stroller portion. A pair of shock absorbers extend between the pair of arcuate handles and the lower cross bar of the stroller portion.

### SUMMARY OF THE INVENTION

The present invention provides a combination jogging apparatus and stroller. A stroller member includes a frame member. A pair of rear wheels, having a first predetermined size, are connected operably to such frame member. At least one front wheel, having a second predetermined size, is connected operably to such frame member. Such frame member having a seat portion disposed therein. A handle bar is attached to an upper end of such frame member.

A pair of handle members, manufactured from a first predetermined material and of a third predetermined size and a predetermined shape, are rotatably connected to the handle bar such that such handle members move up and down and back and forth in fluid motion with a user's arms when such user is jogging.

### OBJECTS OF THE INVENTION

It is, therefore, one of the primary objects of the present invention to provide a combination jogging apparatus and stroller which permits more natural motion of the hands, arms, and shoulders of a user during jogging.

Another object of the present invention is to provide a more comfortable way to push a stroller.

Still another object of the present invention is to provide a way to make traditional strollers into jogging strollers.

Yet another object of the present invention is to provide a combination jogging apparatus and stroller which is easy to use.

An additional object of the present invention is to provide a combination jogging apparatus and stroller that is safer than traditional jogging strollers because it allows more natural jogging type movement of the body while still providing constant contact with the stroller.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a combination jogging apparatus and stroller according to one embodiment of the invention.

FIG. 2 is a perspective view of a jogging apparatus attached to a stroller.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

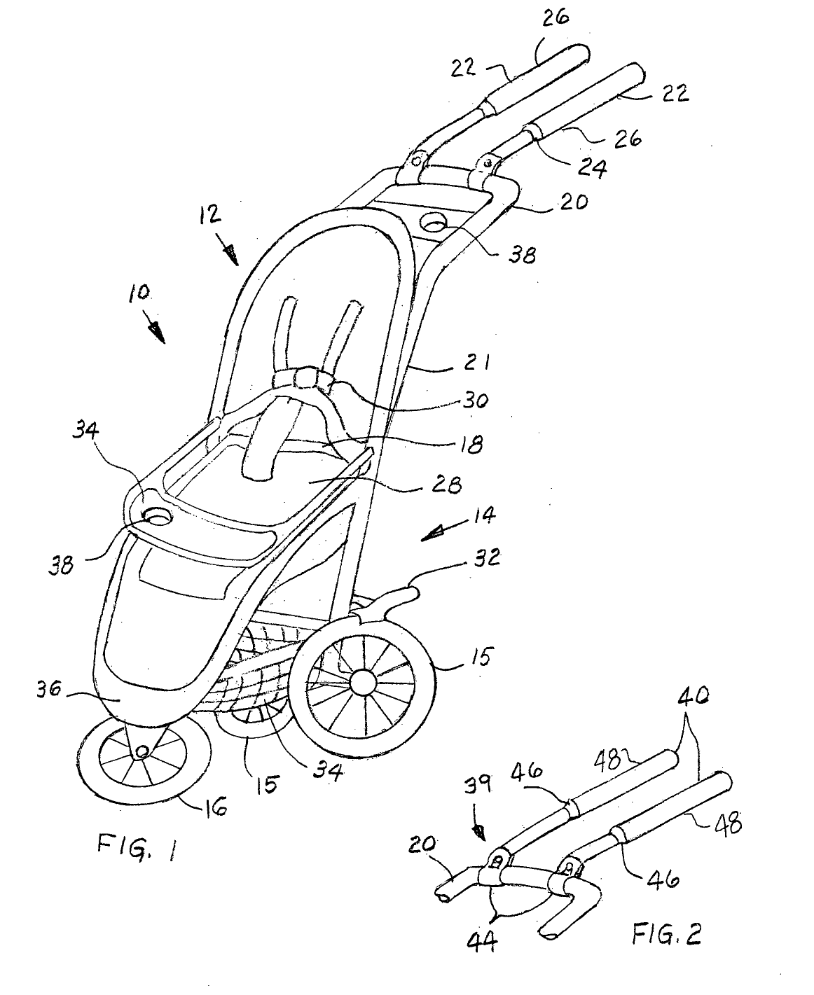

Reference is now made, more particularly, to FIGS. 1-2 According to a first embodiment of the invention, illustrated in FIG. 1, a combination jogging apparatus and stroller, generally designated 10, is provided.

The combination jogging apparatus and stroller 10 includes a stroller member, generally designated 12. The stroller member 12 includes a frame member, generally designated 14. A pair of rear wheels 15, having a first predetermined size, are connected operably to such frame member 14. At least one front wheel 16, of a second predetermined size, is connected operably to such frame member 14. Such frame member 14 has a seat portion 18 disposed therein. A handle bar 20 is attached to an upper end 21 of such frame member 14.

A pair of handle members 22, manufactured from a first predetermined material and of a third predetermined size and a predetermined shape, are rotatably connected to such handle bar 20 such that the handle members 22 move up and down and back and forth in fluid motion with a user's arms (not shown) when such user is jogging.

It is presently preferred that such handle members 22 include an adjustment means 24 for adjusting the size of such handle members 22.

It is further presently preferred that such handle members 22 include a comfort grip portion 26 manufactured from a second predetermined material.

In the presently preferred embodiment the seat portion 18 is formed as a hammock style seat 28 and includes a child restraint means 30.

It is presently preferred that the stroller member 12 includes a locking means 32 for locking at least one of such rear wheels 15 and such at least one front wheel 16.

It is further presently preferred that the stroller member 12 includes a basket member 34 connected to the frame member 14 below the seat portion 18.

In the presently preferred embodiment the stroller member 12 further includes a tray member 34 removeably connected to such frame member 14 such that a child sitting in said seat portion 18 could use the tray member 34 for supporting at least one of snacks, toys, and cups (not shown).

It is further presently preferred that such stroller member 12 includes a foot rest 36 attached to at least one of the seat portion 18 and the frame member 14.

It is presently preferred that such stroller member 12 further includes at least one cupholder 38 at a predetermined location thereon.

According to a second embodiment of the invention, as illustrated in FIG. 2, a jogging apparatus, generally designated 39, is provided. The jogging apparatus includes a pair of handle members 40, manufactured from a predetermined material and of a predetermined size and a predetermined shape. Such pair of handle members 40 are removably connectable to a handle bar 20 of a stroller (not shown). The jogging apparatus further includes a connecting means 44 for removably connecting such handle members 40 to the handle bar 20. Such handle members 40 rotatably move up and down and back and forth in fluid motion with a user's arms (not shown) when such user is jogging while pushing such stroller (not shown).

It is presently preferred that the second embodiment further includes an adjustment means 46 for adjusting the size of such handle members 40.

It is further presently preferred that in the second embodiment such handle members 40 include a comfort grip portion 48 manufactured from a second predetermined material.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A combination jogging apparatus and stroller comprising;
a. a stroller member including a frame member, a pair of rear wheels having a first predetermined size connected operably to said frame member, at least one front wheel of a second predetermined size connected operably to said frame member, said frame member having a seat portion disposed therein, and a handle bar attached to an upper end of said frame member; and
b. a pair of handle members manufactured from a first predetermined material and of a third predetermined size and a predetermined shape, said pair of handle members rotatably connected to said handle bar such that said handle members move up and down and back and forth in fluid motion with a user's arms when such user is jogging.

2. A combination jogging apparatus and stroller according to claim 1 wherein said handle members include an adjustment means for adjusting the size of said handle members.

3. A combination jogging apparatus and stroller according to claim 1 wherein said handle members include a comfort grip portion manufactured from a second predetermined material.

4. A combination jogging apparatus and stroller according to claim 1 wherein said seat portion is formed as a hammock style seat and includes a child restraint means.

5. A combination jogging apparatus and stroller according to claim 1 wherein said stroller member includes a locking means for locking at least one of said rear wheels and said at least one front wheel.

6. A combination jogging apparatus and stroller according to claim 1 wherein said stroller member includes a basket member connected to said frame member below said seat portion.

7. A jogging apparatus comprising:
a. a pair of handle members manufactured from a predetermined material and of a predetermined size and a predetermined shape, said pair of handle members being removably connectable to a handle bar of a stroller; and
b. a connecting means for removably connecting said handle members to said handle bar, said handle members rotatably moving up and down and back and forth in fluid motion with a user's arms when such user is jogging while pushing such stroller.

8. A jogging apparatus according to claim 7 wherein said handle members include an adjustment means for adjusting the size of said handle members.

9. A combination jogging apparatus according to claim 7 wherein said handle members include a comfort grip portion manufactured from a second predetermined material.

10. A combination jogging apparatus according to claim 1 wherein said stroller member further includes a tray member removeably connected to said frame member such that a child sitting in said seat portion could use said tray member for supporting at least one of snacks, toys, and cups.

11. A combination jogging apparatus according to claim 1 wherein said stroller member further includes a foot rest attached to at least one of said seat portion and said frame member.

12. A combination jogging apparatus according to claim 1 wherein said stroller member further includes at least one cupholder at a predetermined location thereon.
